(19) United States
(12) Patent Application Publication
(10) Pub. No.: US 2013/0124040 A1
(43) Pub. Date: May 16, 2013

(54) METHOD FOR CONTROLLING A COMPRESSOR

(71) Applicant: Marek Engelhardt, Friedewald (DE)

(72) Inventor: Marek Engelhardt, Friedewald (DE)

(73) Assignee: CONTINENTAL TEVES AG & CO. OHG, Frankfurt (DE)

(21) Appl. No.: 13/811,698

(22) PCT Filed: Jun. 1, 2011
(86) PCT No.: PCT/EP11/59116

§ 371 Date: Jan. 23, 2013

(30) Foreign Application Priority Data
Jul. 29, 2010 (DE) 10 2010 036 744.3

(51) Int. Cl. B60G 11/27

(52) U.S. Cl. CPC B60G 11/27
USPC 701/37

(57) ABSTRACT

A method for controlling a compressor of a compressed air supply in a vehicle pneumatic suspension. The compressor temperature is calculated using a temperature model and the compressor is switched off or continues to be operated in a different mode of operation when a permissible temperature T_{G} is exceeded. At least two different permissible compressor temperatures T_{G1}<T_{G2} are predetermined. The permissible compressor temperature T_{G1} is predetermined for a first operating state B_{Z1} and the permissible compressor temperature T_{G2} is predetermined for an additional operating state B_{Z2}. In the case that the compressor is or has been already switched on whilst pre-setting the permissible compressor temperature T_{G1} and during this switched-on period or during a subsequent cooling phase a request is made to achieve the second operating state B_{Z2}, the compressor continues to be operated or is switched back on whilst pre-setting the permissible higher compressor temperature T_{G2}.

### CROSS REFERENCE TO RELATED APPLICATIONS

This application is the U.S. National Phase Application of PCT/EP2011/059116, filed Jun. 1, 2011, which claims priority to German Patent Application No. 10 2010 036 744.3, filed Jul. 29, 2010, the contents of such applications being incorporated by reference herein.

### FIELD OF THE INVENTION

The invention relates to a method for controlling a compressor of a compressed air supply in a vehicle pneumatic suspension, in which method the compressor is switched on and off by a pneumatic suspension control according to the air requirement of the vehicle pneumatic suspension and taking into consideration a predetermined permissible compressor temperature T_{G} (compressor temperature limit), in which method the compressor temperature is calculated using a temperature model in an existing, actual or to be achieved, planned operating state of the vehicle pneumatic suspension. In so doing, the compressor is switched off for cooling in all cases in which the compressor temperature that is calculated using a temperature model exceeds a predetermined permissible compressor temperature T_{G}, for example for a period of time that is likewise to be calculated in accordance with a temperature model or, however, the compressor continues to be operated in a different mode, for example in a cyclic mode of operation.

### BACKGROUND OF THE INVENTION

The term ‘operating state’ is understood in this case to mean any function of a pneumatic suspension system that results from cooperating pneumatic and electronic control functions, in other words, for instance, filling the reservoir in the case of a closed-loop level control system and/or pneumatic suspension system, filling the pneumatic springs by open-loop or closed-loop level control systems in order to adjust the ride height of the vehicle, discharging air from the reservoir or pneumatic springs, flowing through and regenerating the dryer, etc.

The mode of operation of a compressor describes the special embodiment of the compressor run and/or operation, for instance, as uninterrupted pumping, as intermittent pumping or as an operation running under full load at maximum counter pressure, as an idling operation, etc.

The term ‘temperature model’ in terms of the application refers to a mathematical model by means of which it is possible to calculate the temperature increase and/or the temperature decrease of the air in the compressor using parameters such as pre-pressure and counter pressure at the compressor, geometric and component embodiments, cooling by means of airflow, battery voltage, environmental pressure, etc. without having to attach a sensor or thermal detector to the compressor.

The method known from DE 196 21 946 C1, which is incorporated by reference, for controlling and/or regulating a compressor that can be switched on and off in dependence upon the requirements can be performed without a thermal detector, since only estimated values for the temperature of the compressor are calculated in the control unit. In addition, the compressor of the pneumatic suspension is protected by the method in a reliable manner against excessively high temperatures, so that any damage to the compressor is to the greatest possible extent excluded even in the case of improper actuation of the pneumatic suspension. However, it is to be established that the upper temperature threshold is always achieved and/or exceeded during a control process and that the control process is then interrupted by the control unit. This means that the control process is not completed or is only completed following a long time delay, namely once the compressor has cooled to below the lower temperature threshold. Since for acoustic reasons and in order to provide protection against mechanical loadings the compressors of a pneumatic suspension are in most cases well encased, the cooling time can occupy a period of time of a few minutes up to a quarter of an hour. An interruption and/or delay of such a length in the control process is unsatisfactory.

DE 10 2006 039 538 A1, which is incorporated by reference, discloses a method for controlling a compressor of a pneumatic suspension system of a motor vehicle, which compressor is switched on and off in dependence upon the requirements, in which method the temperature of the air that is compressed in the compressor is calculated using a temperature model during the operating periods of the compressor and in which method the basis for the first operation of the compressor is a different temperature model than for the subsequent operations of the compressor, which results in an extension of the first operating period of the compressor in comparison to the subsequent operating periods. Consequently, more control processes can be performed to the end but by no means all control processes.

A particular problem always arises then if it is or was necessary to fill the level control system by means of the compressor in order to provide the necessary volume of air for the system and the compressor in so doing has been heated to almost its permissible compressor temperature limit. If then in addition or also shortly afterwards it is desired to adjust the ride height of the vehicle, for example for entering an open country course or following an increased vehicle payload, the concurrent temperature model in accordance with the prior art establishes that the control request “adjust the ride height of the vehicle” cannot be performed without exceeding the permissible compressor temperature limit during the course of the compressor operation required for this purpose. Consequently, the control request is not granted and the switching-on of the compressor is “disabled” by the control. It is possibly necessary for the driver to wait several minutes until the compressor has cooled to such an extent that the adjustment of the ride height can be performed without the permissible compressor temperature limit being exceeded. This delay is unsatisfactory for the driver as he might assume that his level control system and/or pneumatic suspension system is not functioning correctly.

### SUMMARY OF THE INVENTION

An aspect of the invention is therefore to provide a method for controlling a compressor of a compressed air supply in a vehicle pneumatic suspension, in which method on the one hand all components of the compressor are well protected from damage caused by the development of excessive heat and, on the other hand, different control requests that occur simultaneously or consecutively, i.e. requests for achieving particular operating states, can be performed where possible without any waiting times.

This aspect is achieved by means of a method for controlling a compressor of a compressed air supply in a vehicle pneumatic suspension, in which method the compressor is switched on and off by a pneumatic suspension control according to the air requirement of the vehicle pneumatic suspension and taking into consideration a predetermined permissible compressor temperature T_{G}, in which method the compressor temperature is calculated using a temperature model in an existing operating state B_{Z} of the vehicle pneumatic suspension or for an operating state B_{Z} of the vehicle pneumatic suspension to be achieved, and in which method the compressor is switched off or continues to be operated in a different mode of operation in the cases in which the compressor temperature that is calculated using a temperature model exceeds the predetermined permissible compressor temperature T_{G}, wherein at least two different permissible compressor temperatures T_{G1} and T_{G2} are predetermined and the permissible compressor temperature T_{G2} is greater than the permissible compressor temperature T_{G1}, wherein the permissible compressor temperature T_{G1} is predetermined for a first operating state B_{Z1} of filling the vehicle pneumatic suspension and the permissible compressor temperature T_{G2} is predetermined for an additional operating state B_{Z2} of filling the vehicle pneumatic suspension, wherein in the case that the compressor is or has been already switched on whilst pre-setting the permissible compressor temperature T_{G1} in order to achieve the first operating state B_{Z1} and during this switched-on period or during a subsequent cooling phase of the compressor a request is sent to the vehicle control to achieve the second operating state B_{Z2}, the compressor continues to be operated or is switched back on whilst pre-setting the permissible higher compressor temperature T_{G2}.

### DETAILED DESCRIPTION OF THE INVENTION

In this case, at least two different permissible compressor temperatures T_{G1} and T_{G2} are predetermined as parameters in the control program, of which said temperatures the permissible compressor temperature T_{G2} is greater than the permissible compressor temperature T_{G1}, The permissible compressor temperature T_{G1} is predetermined for a first operating state B_{Z1} of filling the vehicle pneumatic suspension and the permissible compressor temperature T_{G2} is predetermined for an additional operating state B_{Z2} of filling the vehicle pneumatic suspension. In the case that the compressor is or has been already switched on whilst pre-setting the permissible compressor temperature T_{G1} in order to achieve the first operating state B_{Z1} and during this switched-on period or during a subsequent cooling phase of the compressor a request that is instigated from outside, i.e. possibly by the driver, is sent to the vehicle control to achieve the second operating state B_{Z2}, the compressor continues to be operated or is switched back on whilst pre-setting the permissible higher compressor temperature T_{G2}. A subsequent cooling phase could be initiated, for example, by the permissible compressor temperature T_{G1} being exceeded and the consequently triggered switching-off of the compressor.

In the case of the method in accordance with the invention, it is consequently also possible to use the compressor for performing the control requests even if the performance of other tasks already require or have required a compressor operation, which operation would heat the compressor to the temperature limit T_{G1}. As a consequence, an “operating period reserve”, so to speak, for the compressor is obtained.

An advantageous development resides in the fact that the first operating state B_{Z1} is filling the reservoir of a closed pneumatic suspension system and the additional operating state B_{Z2} is adjusting the ride height of the vehicle. Consequently, it is possible during and after filling the reservoir also to initiate an adjustment of the ride height of the vehicle according to the driver's request. In the case of the control of the compressor operation in a level control system in accordance with the prior art, the compressor is, in contrast, in most cases no longer available for a subsequent level control process after the reservoir has been filled. If the driver requests a control process by way of the operating element, he is notified in the prior art by means of the display in the dashboard that it is not possible to perform a control operation at the moment.

The customer and/or the driver can perform a control operation at any time and is not forced to accept a waiting time when performing this control operation. This is a decisive advantage with respect to customer satisfaction particularly in situations in which the vehicle has just been started, in the case of the so-called “terminal 15-exchange” and in situations when upon establishing a loss of pressure/loss of volume the reservoir is obligatorily filled.

The compressor operation is, so to speak, divided into a “background operation”, i.e. the filling process that is not generally registered by the customer, and into a customer-relevant operation, i.e. into the “ride height control request”. By means of introducing in this manner independent switch-off temperatures, i.e. a permissible compressor temperature T_{G1} and T_{G2} within the temperature model, namely T_{G1} for the background mode of operation of the compressor and the higher T_{G2} for the customer-relevant operation, it can be ensured that a customer-relevant operation can almost always be performed. In addition, as a customer-relevant compressor operation is initiated, a compressor that is currently disabled owing to cooling is immediately enabled. This is particularly advantageous by virtue of the fact that the operation of the compressor is independent of its counter pressure and/or of the reservoir pressure.

A further advantageous development resides in the fact that the permissible compressor temperature T_{G1} for the first operating state B_{Z1} is limited to 180° C., possibly in cooperation with an embodiment in which the permissible compressor temperature T_{G2} for the second operating state B_{Z2} is limited to 200° C. These are temperature limits which the method in accordance with the invention renders extremely easy to apply for the types of compressors and compressor materials currently available on the market.

When using the method in accordance with the invention problems no longer occur, for example, in the following situations:

If the vehicle has been subjected to intensive use on the previous day, the air in the pneumatic springs has been greatly warmed owing to the heat of the engine, the shock absorbers, etc. It is also possible to establish a slight warming of the air in the air reservoir. The vehicle is then parked up and cools overnight. In so doing, the volume of air available in the system reduces. The air “contracts”.

On the following day, the vehicle is taken back into operation. Initially, the control device establishes that the volume of air available in the system is too low and a process of filling the reservoir is now commenced in order to increase the volume of air to the required amount. If the compressor after checking by means of the temperature model actually achieves or is expected to achieve the permissible compressor temperature T_{G1} of 180° C. and consequently the temperature at which it is switched off, then the compressor in accordance with the method in the prior art would be disabled for the following activities.

In the meantime, the customer has now loaded the vehicle; he gets into the vehicle and now wishes to start a level control process. In accordance with the method hitherto known in the prior art, the compressor was at this point not available. The compressor had to first cool in accordance with a temperature model and only after cooling could it perform the desired control process.

When using the method in accordance with the invention and consequently with the introduction of a second permissible compressor temperature T_{G2} within the temperature model and the interruption of the cooling phase, the compressor can be used immediately by the system. The control process is generally considerably shorter than the duration of the process of filling the reservoir.

The scenario illustrated above occurs more frequently in the winter months. Consequently, the “control performance” in accordance with the invention and as perceived subjectively by the driver is considerably greater by means of the use of this new method embodiment than when using methods in the prior art. The increase in control performance of a pneumatic suspension system is of considerable additional value for the customer.

An additional advantageous embodiment of the method resides in the fact that the compressor is operated uninterrupted until the first permissible compressor temperature T_{G1} is achieved and once the second permissible compressor temperature T_{G2} is achieved it is operated in a cyclic/intermittent manner. If it is possible to establish by means of the temperature model that the estimated temperature would exceed the permissible compressor temperature T_{G2}, then the compressor is operated uninterrupted until T_{G2} is achieved and after achieving T_{G2} the compressor is operated in a cyclic manner. Tests have surprisingly shown that in the case of a cyclic operation the compressor does not heat up considerably more. This depends naturally on the type of construction and upon the installation site of the compressor, but is true in the case of many designs. The tests mentioned have also shown that with respect to the service strength and the collective loading of the compressor approx. 10% of the compressor operating period may be performed above a permissible compressor temperature T_{G2} of 200° C. without damage, in particular in the intermittent, cyclic operation.

The use of the temperature model naturally also allows that, in the cases in which a calculation of the compressor temperature that would be set after completing the control process desired by the driver indicates that the temperature predicted in this manner is greater than a predetermined switch-off temperature, the desired control process is not performed. The switch-off temperature can, for example, be somewhat greater than T_{G2}. In this case, in which the actually desired control operation/the desired control process is not performed or not fully performed, it is possible if necessary to perform a predetermined “alternative control process” that comes as close as possible to the desired control process or that causes an “intermediate level” to be initiated, in which the vehicle is once again “level” directly after the control process.

A further advantageous embodiment of the method resides in the fact that an enquiry is made by means of the control device at a frequency of 2 Hz as to whether, during the switched-on period of the compressor in order to achieve the first operating state B_{Z1} or during the subsequent cooling phase of the compressor, a request is made to achieve the second operating state B_{Z2}. Consequently, the enquiry frequency is so high that the driver who desires the control process and will switch accordingly, does not knowingly notice any delay.

A further advantageous embodiment of the method resides in the fact that the compressor continues to be operated or is switched back on in dependence upon the volume of air located in the system whilst pre-setting the permissible higher compressor temperature T_{G2}.

If the volume of air in the system is below a minimum value, the control process that is desired by the driver is consequently not performed. It can even be advantageous to fill the volume of air in the system first back up to a minimum level prior to the method in accordance with the invention, i.e. prior to an “operating period reserve”, being enabled. The pressure differences between the reservoir pressure and the pneumatic spring pressure during the up or down control process are even smaller if the volume of air in the system comprises a minimum level in comparison to a system having too little air. The compressor is then not heated too greatly during the control process and longer control processes can be performed.

The advantage of an embodiment of this type—in dependence upon the volume of air located in the system—is also evident in the case of regeneration processes that are performed when filling the reservoir in order to achieve the required increased volume of air in the system. Processes of this type are then not interrupted by the performance of the method in accordance with the invention.

A further advantageous embodiment of the method resides in the fact that the compressor continues to be operated or is switched back on in dependence upon the ride height of the vehicle whilst pre-setting the permissible higher compressor temperature T_{G2}.

If the vehicle is sitting generally too low, for example on the overload spring, also referred to as a damping device, or if the vehicle is sitting too high, i.e. in the traction stop, then the method in accordance with the invention is consequently not performed. In addition, it is consequently possible that even if a requested control process exceeds a particular adjustment in the ride height, e.g. 20 mm upwards or downwards, then the method in accordance with the invention is not performed. In the case of this embodiment, it is generally not possible for a control request to be performed to the end when performing the method in accordance with the invention. Consequently, for example, any upwards control from the damping devices after a payload change can simply take too long. In the case of a control operation, for example, of only 20 mm adjustment distance, the loading on the system is in contrast not inadmissibly high.

A pneumatic suspension or level control system for a motor vehicle having a control device that performs the method in accordance with the invention for control purposes is particularly suitable for private cars, in particular combi-vehicles or, in which a driver is more likely to frequently request an adjustment of the ride height.

1. A method for controlling a compressor of a compressed air supply in a vehicle pneumatic suspension, in which the compressor is switched on and off by a pneumatic suspension control according to the air requirement of the vehicle pneumatic suspension and taking into consideration a predetermined permissible compressor temperature T_{G},
in which method the compressor temperature is calculated using a temperature model in an existing operating state B_{Z} of the vehicle pneumatic suspension or for an operating state B_{Z} of the vehicle pneumatic suspension to be achieved, and
in which method the compressor is switched off or continues to be operated in a different mode of operation in the cases in which the compressor temperature that is calculated using a temperature model exceeds the predetermined permissible compressor temperature T_{G},
wherein at least two different permissible compressor temperatures T_{G1} and T_{G2} are predetermined and the permissible compressor temperature T_{G2} is greater than the permissible compressor temperature T_{G1},
wherein the permissible compressor temperature T_{G1} is predetermined for a first operating state B_{Z1} of filling the vehicle pneumatic suspension and the permissible compressor temperature T_{G2} is predetermined for an additional operating state B_{Z2} of filling the vehicle pneumatic suspension,
wherein in the case that the compressor is or has been already switched on whilst pre-setting the permissible compressor temperature T_{G1} in order to achieve the first operating state B_{Z1} and during this switched-on period or during a subsequent cooling phase of the compressor a request is sent to the vehicle control to achieve the second operating state B_{Z2}, the compressor continues to be operated or is switched back on whilst pre-setting the permissible higher compressor temperature T_{G2}.

2. The method as claimed in claim 1, in which the first operating state B_{Z1} is filling the reservoir of a closed pneumatic suspension system and the additional operating state B_{Z2} is adjusting the ride height of the vehicle.

3. The method as claimed in claim 1, in which the operation of the compressor is independent of its counter pressure and/or of the reservoir pressure.

4. The method as claimed in claim 1, in which the permissible compressor temperature T_{G1} for the first operating state B_{Z1} is limited to 180° C.

5. The method as claimed in claim 1, in which the permissible compressor temperature T_{G2} for the second operating state B_{Z2} is limited to 200° C.

6. The method as claimed in claim 1, in which the compressor is operated uninterrupted until the first permissible compressor temperature T_{G1} is achieved and once the second permissible compressor temperature T_{G2} is achieved it is operated in a cyclic/intermittent manner.

7. The method as claimed in claim 1, in which an enquiry is made by means of the control device at a frequency of 2 Hz as to whether, during the switched-on period of the compressor in order to achieve the first operating state B_{Z1} or during the subsequent cooling phase of the compressor, a request is made to achieve the second operating state B_{Z2}.

8. The method as claimed in claim 1, in which the compressor continues to be operated or is switched back on in dependence upon the volume of air located in the system whilst pre-setting the permissible higher compressor temperature T_{G2}.

9. The method as claimed in claim 1, in which the compressor continues to be operated or is switched back on in dependence upon the ride height of the vehicle whilst pre-setting the permissible higher compressor temperature T_{G2}.

10. A pneumatic suspension or level control system for a motor vehicle having a control device which performs a method for controlling a compressor of a compressed air supply in a vehicle pneumatic suspension, in which the compressor is switched on and off by a pneumatic suspension control according to the air requirement of the vehicle pneumatic suspension and taking into consideration a predetermined permissible compressor temperature T_{G}, in which method the compressor temperature is calculated using a temperature model in an existing operating state B_{Z} of the vehicle pneumatic suspension or for an operating state B_{Z} of the vehicle pneumatic suspension to be achieved, and in which method the compressor is switched off or continues to be operated in a different mode of operation in the cases in which the compressor temperature that is calculated using a temperature model exceeds the predetermined permissible compressor temperature T_{G}, wherein at least two different permissible compressor temperatures T_{G1} and T_{G2} are predetermined and the permissible compressor temperature T_{G2} is greater than the permissible compressor temperature T_{G1}, wherein the permissible compressor temperature T_{G1} is predetermined for a first operating state B_{Z1} of filling the vehicle pneumatic suspension and the permissible compressor temperature T_{G2} is predetermined for an additional operating state B_{Z2} of filling the vehicle pneumatic suspension, wherein in the case that the compressor is or has been already switched on whilst pre-setting the permissible compressor temperature T_{G1} in order to achieve the first operating state B_{Z1} and during this switched-on period or during a subsequent cooling phase of the compressor a request is sent to the vehicle control to achieve the second operating state B_{Z2}, the compressor continues to be operated or is switched back on whilst pre-setting the permissible higher compressor temperature T_{G2}.
